(19) United States
(12) Patent Application Publication
(10) Pub. No.: US 2011/0194167 A1
(43) Pub. Date: Aug. 11, 2011

(54) MULTI-SEGMENTED DISPLAYS

(76) Inventors: Jeanette Elisabeth Jackson, Coquitlam (CA); Yohann Sulaiman, Maple Ridge (CA); Miroslav Grotkowski, North Vancouver (CA); Verne Jackson, Maple Ridge (CA)

(21) Appl. No.: 12/784,450

(22) Filed: May 20, 2010

Related U.S. Application Data
(60) Provisional application No. 61/271,284, filed on Jul. 20, 2009.

(51) Int. Cl. G02B 26/00; F21V 11/00; F21V 7/00

(52) U.S. Cl. 359/290; 362/237; 362/230; 362/615

(57) ABSTRACT

A display comprises a block of optically transparent materials. Patterns are etched within the block. The patterns may be selectively illuminated by light directed into sides of the block. Barriers divide the block or layers within the block into segments. Patterns in different segments and/or in different layers of the block may be independently illuminated. In some embodiments the block is made up of a number of sheets of optically transmissive material. The block may permit viewing of display elements or other objects or things located behind the block. Patterns may be configured to scatter preferentially light of specific polarizations. Displays may be applied in a wide variety of applications including in vehicles, as displays on electronic devices and the like.

### REFERENCE TO RELATED APPLICATION

This application claims the benefit under 35 U.S.C. 119 of U.S. application No. 61/271,284 filed 20 Jul. 2010 and entitled LOW-COST COLOR TRANSPARENT DISPLAY USING MULTISEGMENTED MULTIPLANAR PANELS which is hereby incorporated herein by reference.

### TECHNICAL FIELD

This invention relates to displays. Examples of applications in which displays may be applied include: displays which are configured to display information to operators or passengers in vehicles such as cars, trucks, airplanes, boats; displays which are configured to display information to users of electronic equipment and the like. Some embodiments provide Head UP displays (HUDs).

### BACKGROUND

The following patents and applications describe some example displays:
US 2005078485A1;
US 2006207134A1;
US 2007171674A1;
U.S. Pat. No. 3,728,673;
U.S. Pat. No. 4,045,794;
U.S. Pat. No. 4,555,694;
U.S. Pat. No. 4,949,489;
U.S. Pat. No. 5,743,616;
U.S. Pat. No. 6,663,252;
U.S. Pat. No. 7,427,143;
U.S. Pat. No. 7,594,349.
   Some of these displays comprise edge-lit displays of the type in which patterned sheets are illuminated from the side to cause a pattern on the sheets to be made visible.

A Head Up Display (HUD) is a display capable of projecting information directly into a human's visual field. HUDs and elements for HUDs are described, for example, in:
U.S. Pat. No. 5,436,763, entitled “Wide Spectral Bandwidth Virtual Image Display Optical System”;
U.S. Pat. No. 6,236,511, entitled “Beam Combining Optical Element”, Some prior HUDs have the disadvantage of being expensive and/or undesirably bulky.

There remains a need for cost-effective displays for use in a wide range of applications and for displays which provide alternatives to existing display technologies.

### SUMMARY

This invention provides displays and methods for making displays. The invention has several aspects that may be applied in combination with one another or individually.

One aspect provides side-lit displays comprising at least one side-lit block or layer. The side-lit block or layer includes a barrier at which light is deflected or absorbed such that patterns on opposing sides of the barrier may be illuminated independently. The barrier may be formed by sub-surface etching.

Another aspect provides side-lit displays in which etched patterns can be selectively illuminated. The patterns are etched in such a manner that they interact primarily with light having specific polarizations. The patterns are selectively illuminated with light of appropriate polarizations.

Another aspect provides a display comprising an optically transparent block. The block has a front face and one or more sides. At least one barrier is defined in the block. The barrier divides the block into a plurality of segments. At least one light source is associated with each of the segments. The light sources are optically connected to emit light into one of the one or more sides. At least one patterned area is provided in each of the segments. The patterned areas may, for example, have the form of icons, letters, numerals, words, or the like. The patterned area is configured to scatter light so as to be visible through the front face when illuminated by the associated light source. The barrier is configured to block light from the light source associated with one of the segments from illuminating the patterned area in a different one of the segments.

Another aspect provides head-up displays which include side lighting by a plurality of multicolored light-emitting devices.

Another aspect provides side-lit displays comprising ferrofluidic display elements.

Another aspect provides methods for making displays which include etching patterns in one or more side-lit layers using polarized light.

Displays as described herein have example application in commercial, industrial and consumer visual displays, indicator lighting and other visual interfaces such as HUDs.

Other aspects of the invention and features of a range of example embodiments are described below and shown in the accompanying drawings.

### BRIEF DESCRIPTION OF THE DRAWINGS

The appended drawings illustrate various example embodiments of the invention. The drawings are non-limiting and are illustrative rather than restrictive.

FIG. 1 is a schematic view illustrating a display according to an example embodiment.

FIGS. 1A and 1B are cross sectional views of the display of FIG. 1 in the planes indicated by 1A-1A and 1B-1B respectively.

FIG. 1C shows an example of a block made up of different layers.

FIG. 1D is a side view of a display having four layers.

FIG. 1E shows schematically a cross-section through a block in which optical layers are sandwiched between adjacent layers of the block.

FIG. 2 shows a display according to another embodiment which includes an indicator.

FIG. 3 shows an example control circuit for light sources of a display.

FIG. 3A shows a LED lighting structure that may be used to provide light sources for a display.

FIG. 4 is a side view of a gauge/indicator according to another example embodiment.

FIG. 5 shows a display according to another example embodiment in which patterns comprise cavities into which a light-scattering fluid may be introduced.

FIG. 6 shows a circuit that may be used to control coils in a display like that of FIG. 5.

### DESCRIPTION

Throughout the following description specific details are set forth in order to provide a more thorough understanding to persons skilled in the art. However, well known elements may not have been shown or described in detail to avoid unnecessarily obscuring the disclosure.

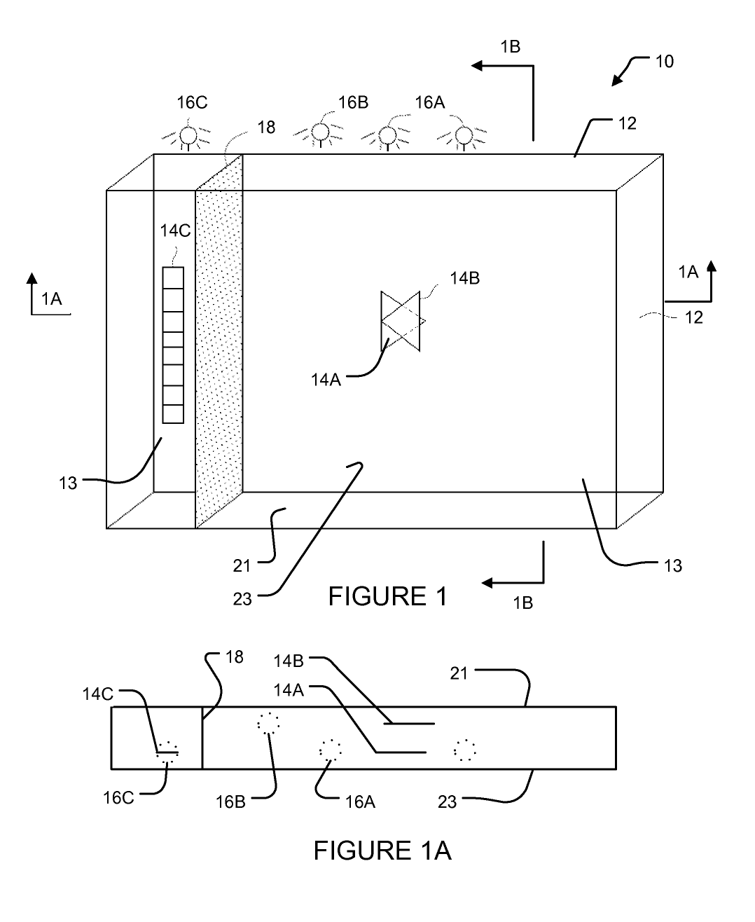

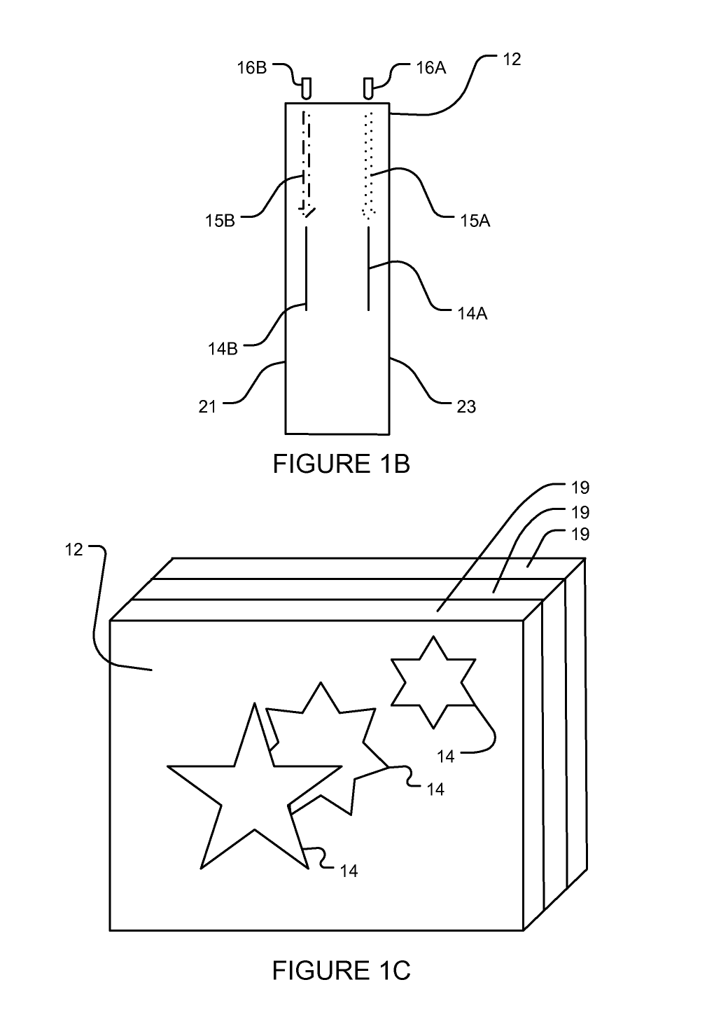

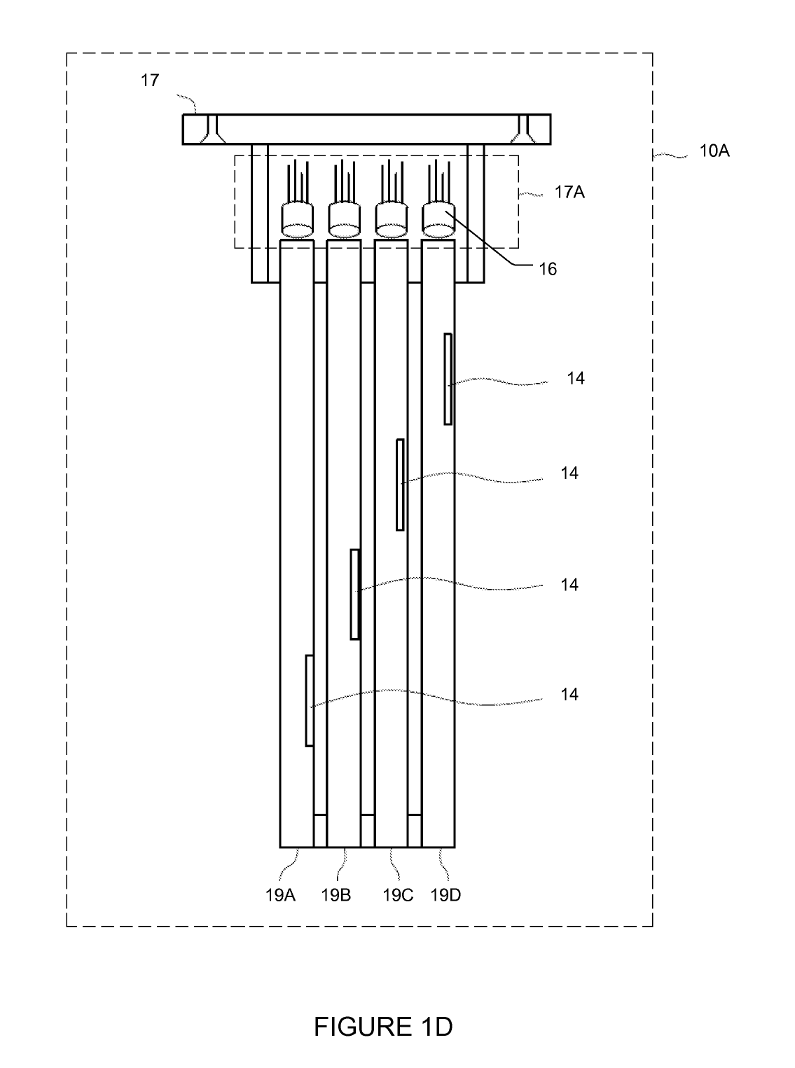

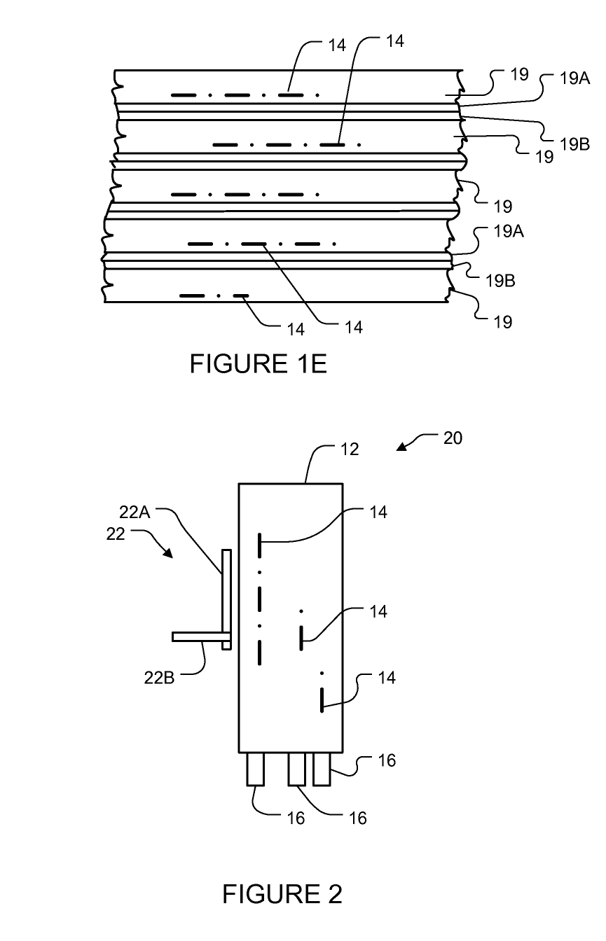

FIGS. 1, 1A and 1B show an example display 10 comprising a sheet or block of a light-transmissive material. Block 12 may, for example, comprise glass, polycarbonate or another suitable transparent plastic, or the like. Block 12 is etched using a subsurface engraving technique to provide a plurality of patterns 14A, 14B, 14C (collectively or generally patterns 14). Different patterns 14 are at different depths within block 12.

Patterns 14 may be made to suit an intended application of display 10. For example, patterns 14 may comprise arrows, numbers, words, letters, icons, symbols, geometric elements, or the like.

Light sources 16A, 16B, 16C (collectively or generally light sources 16) are provided adjacent one or more sides of block 12. When one of light sources 16 is operated, light from the light source 16 enters block 12 and illuminates one or more of patterns 14, thereby making the illuminated patterns 14 stand out to an observer viewing display 10. For example, as shown in FIG. 1B, light 15A from light sources 16A illuminates pattern 14A and light 15B from light source 16B illuminates pattern 14B.

In the illustrated embodiment, light sources 16A and 16B are configured to emit light that illuminates patterns 14 at different depths (as measured, for example, from the front face 21 of block 12). In some embodiments light sources 16 emit, or can be controlled to emit, light of different colors such that different patterns 14 may be simultaneously made visible in different colors or the same pattern 14 may be displayed at different times to have different colors.

In the illustrated embodiment, a barrier 18 is etched within block 12. Barrier 18 comprises an etched surface within block 12 such that light propagating in block 12 on one side of barrier 18 tends not to propagate through barrier 18. For example, barrier 18 may scatter and attenuate light that hits it or scatter or reflect light in a direction away from the viewer. In the illustrated embodiment, barriers 18 extend substantially perpendicularly to the front surface 21 of block 12 and patterns 14 extend substantially parallel to front surface 21.

The presence of barrier 18 facilitates the independent display of patterns on either side of barrier 18. For example, in the illustrated embodiment, patterns 14A and 14C are at the same depth within block 12. Light from light source 16A would illuminate both of patterns 14A and 14C if it were not for the presence of barrier 18 between patterns 14A and 14C. Similarly, light from light source 16C would illuminate both of patterns 14A and 14C if it were not for the presence of barrier 18.

Barrier 18 and patterns 14 may be formed using the same etching processes. Preferably barrier 18 is constructed such that light from light sources 16 propagating within block 12 does not scatter off of barrier 18 toward the viewing side of display 10. In some embodiments a plurality of barriers 18 are provided to divide the volume of block 12 into a plurality of different segments 13 within which the illumination of patterns 14 can be separately controlled. In alternative embodiments, barriers 18 may be formed by depositing light scattering and/or absorbing particles within block 12, making cuts in block 12 and/or inserting or forming opaque barriers in block 12.

The provision of barriers 18 permits different regions or ‘segments’ 13 (and patterns 14 in those regions) to be illuminated or not illuminated independently of one another and/or to be illuminated with light of different colors. Thus, displays which incorporate barriers 18 may be made in a way that facilitates richer displays of information by way of patterns 14 that are packed relatively closely together and yet can be independently illuminated.

Barriers 18 may extend all of the way through block 12 from front surface 21 to back surface 23. This is not mandatory. In some embodiments barriers 18 only block the passage of light in certain layers within block 12. In some embodiments, barriers 18 are formed so as to divide a display or a display layer into two, three or more distinct segments such that patterns 14 in any one of the distinct segments may be illuminated independently of patterns 14 in others of the distinct segments.

In some embodiments, patterns 14 and/or barriers 18 are formed by laser etching of block 12. This may be achieved, for example, through the use of commercially-available sub-surface laser engraving systems (SSLE systems). Patterns 14 and barriers 18 may be defined in terms of computer generated graphics and a computer-controlled SSLE system may be used to form patterns 14 and barriers 18 within block 12.

Some embodiments are structurally similar to display 10 except that block 12 comprises a plurality of separate layers 19 stacked together. In such embodiments, patterns 14 may be formed on surfaces of the individual layers 19 by, for example, selectively sandblasting, embossing, abrading, or applying light-scattering material to form patterns 14. In addition, or in the alternative, sub-surface engraving techniques may be applied to form patterns 14 within layers 19 of block 12. The layers 19 may then be clamped and/or bonded together to form block 12. In some embodiments, layers 19 are coated or are separated by sheets of material having optical characteristics such that light tends to remain within layers 19 until it is scattered by interaction with a pattern 14 or barrier 18. An example of a block 12 made up of different layers 19 is illustrated in FIG. 1C.

FIG. 1D is a side view of a display 10A having four layers. Each layer comprises a panel 19. Panels 19A, 19B, 19C and 19D are shown. There may be more or fewer panels 19 depending on the application. A panel housing structure 17 holds panels 19 in place. Housing structure 17 may also support an assembly 17A in which light sources 16 are mounted. In the alternative, light sources 16 may be mounted in some other manner, for example on another edge of panels 19. In the illustrated example embodiment, patterns 14 are etched so that they are parallel to the major faces of panels 19 for the best visual display. A display like display 10A can provide layers of information or multi colored images, or can display three-dimensional structures assembled from patterns 14 in different layers 19.

In some embodiments, display layers 19 are separated from one another by optical films. The optical films may be sandwiched between layers 19. FIG. 1E shows an example embodiment wherein a one-way reflective film 19A and a microdiffusion film 19B are sandwiched between adjacent layers 19. Microdiffusion film 19B diffuses light directed to the viewer. the presence of such a film can hide visible interactions of light passing from a deeper pattern 14 through a non-illuminated pattern 14 that is closer to the viewer. One way film 19A prevents light incident from the viewing direction from entering diffuser 19B. This prevents illumination of a deeper non-illuminated pattern 14 by stray light.

FIG. 2 shows a display 20 according to another embodiment. Display 20 incorporates a mechanical or electronic indicator 22 located behind block 12. Indicator 22 can be viewed through block 12. Patterns 14 can be selectively illuminated and, when so illuminated, appear to the user in front of indicator 22. In the illustrated embodiment, indicator 22 comprises a needle 22A supported to rotate on a shaft 22B driven by a suitable actuator (not shown). Needle 22A may be optionally illuminated by a light source (not shown) in needle 22A or optically coupled to needle 22A by an optical fiber or other light guide.

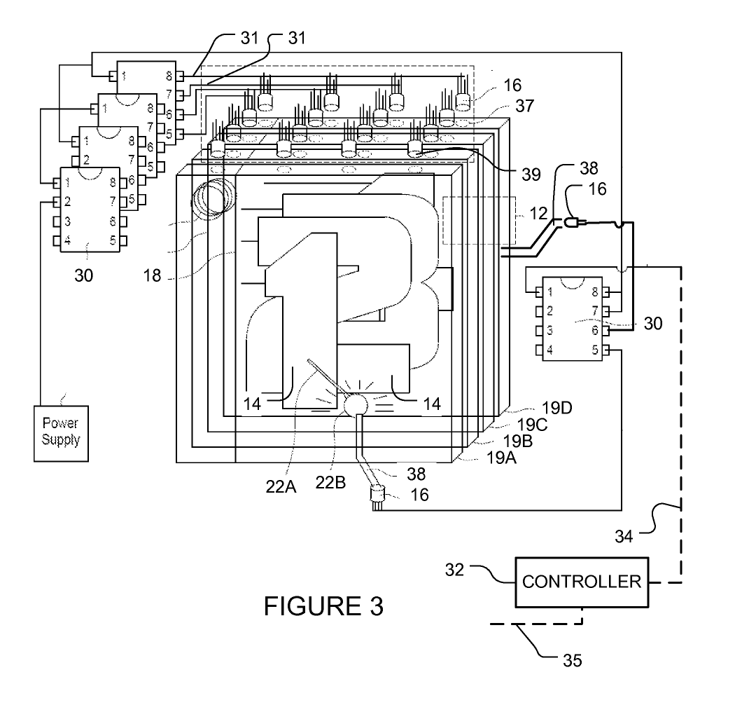

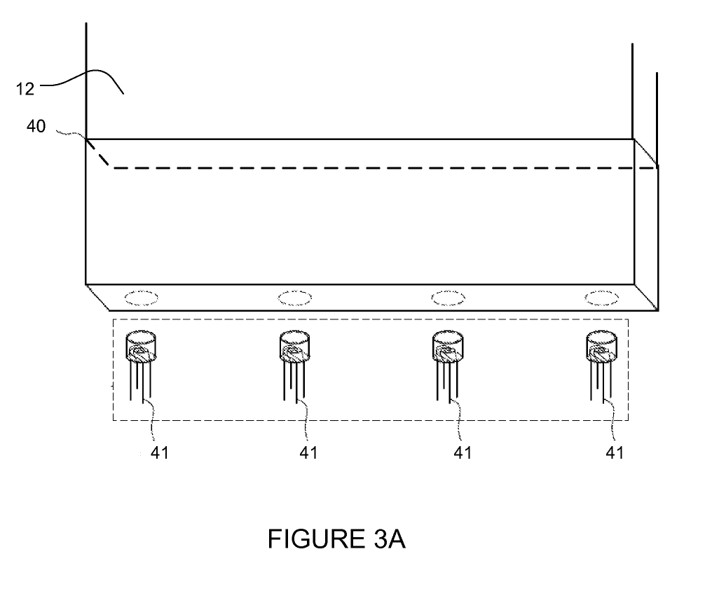

FIG. 3 shows an example control circuit for light sources 16 of a display of a type described herein. In the illustrated embodiment one or more control chips 30 are connected to drive light sources 16. Each control chip 30 comprises a plurality of outputs 31. Each output 31 can drive one or more light sources 16. The light sources 16 connected to each output 31 are oriented so that emitted light illuminates one or more corresponding patterns 14.

In some embodiments there may be two or more corresponding patterns 14 that are intended to be always illuminated together. In such embodiments a single output 16 may control one or more light sources 16 that collectively illuminate the two or more corresponding patterns 14. In some embodiments, some or all of the two or more corresponding patterns 14 are in different layers from one another and/or are in different segments from one another separated by barriers 18.

Light sources 16 corresponding to one output 31 may be oriented to illuminate corresponding patterns 14 that are different from those illuminated by the light sources 16 connected to other outputs 31.

In some embodiments, light sources 16 controlled by one output 31 illuminate a particular layer within a display and/or a different segment within a layer with light of a particular color. Sufficient outputs 31 may be provided to individually control the illumination of each pattern 14 (or group of patterns 14). In some embodiments, light sources of a plurality of colors are provided to illuminate some or all patterns 14. In such embodiments the pattern 14 may be illuminated in any selected one of the plurality of colors, illuminated in a combination of the plurality of colors or not illuminated by appropriately controlling outputs 31.

A data link 35 brings external sensor input and/or control signals that indicate which features of the display should be illuminated (and in which color in some embodiments) to a main display controller 32. Display controller 32 is connected to control the individual control chips 30 by way of a communication bus 34. Communication bus 34 may have any suitable architecture. For example, bus 34 may be connected to deliver communication signals from main display controller 32 directly to each control chip 30, control chips 30 may be daisy chained such that control signals pass to some control chips 30 by way of other control chips 30, or the like.

Controller 32 may operate light sources to provide a range of visible effects. For example, controller 32 may:
operate selected light sources to illuminate and thereby make visible one or more selected ones of patterns 14;
control the colors of light sources so as to cause one or more corresponding patterns 14 to appear in selected colors;
control the light source over time so as to produce from the illuminated display at least one dynamic lighting effect (i.e. an effect that involves changes in some characteristic of the lighting over time);
etc.
   Non-limiting examples of dynamic lighting effects include:
Controlling the brightness of individual light sources or groups of light sources to cause the visibility and or appearance of patterns 14 to vary over time.
Controlling the brightness of light sources of different colors to cause selected patterns 14 to be visible in a selected color. The color may be made to change over time.
Controlling the color of one or more light sources and thereby causing selected patterns 14 to be visible in changing colors.
Causing light sources to switch on and off thereby making corresponding patterns 14 appear to blink.
etc.

In the embodiment illustrated in FIG. 3, light from light sources 16 is coupled to appropriate locations 37 on the sides of block 12. Light sources 16 may be mounted to emit light directly into block 12 or light may be carried from light sources 16 to block 12 by way of light guides. Light guides may, for example, comprise light pipes, fused light interfaces, or the like. The light guides may be direct light to enter block 12 in the desired plane and segment to illuminate one or more corresponding patterns 14. Light guides may comprise focusing elements 39 configured to focus emitted light into a desired plane within block 12.

Various materials and techniques may be applied to hold light sources 16 in place. For example, light sources 16 may be bonded to light guides or directly to block 12 using suitable adhesives. For example, transparent potting material or cyanoacrylate adhesives may be used to hold light sources 16 in place in some embodiments.

In the embodiment illustrated in FIG. 3, a light guide 38 is provided to carry light from a light source 16 to illuminate a needle 22A another light guide 38 is provided to carry light from a light source 16 to a location on one of the sides of block 12. In some alternative embodiments, suitable light guides 38 connect all light sources 16 to locations on sides of block 12.

FIG. 3A shows a LED lighting structure 40 that may be used to provide one or more light sources 16 for a display as described herein. Lighting structures 40 may be positioned along one or more sides of a block 12. Lighting structure 40 comprises a linear array of LEDs 41 that can be spaced apart along one side of a block 12 or a layer 19 within a block 12. LEDs 41 are optically bonded to block 12 using a transparent material such as cyanoacrylate cement and/or transparent glue. LEDs 41 may be energized to provide even illumination of a layer of block 12. In the illustrated embodiment, LEDs 41 have flat tips located close to the light-emitting junction of the LEDs. LEDs 41 may be modified from LEDs having packages with integral lenses by removing the integral lenses by sanding, sawing, laser cutting, or the like and then polishing. LEDs packaged with integral lenses may also be used at the cost of some efficiency.

LEDs 41 may comprise any suitable types of LEDs including RGB, single color, round, square, large, small, standard or high-emitting, white LEDs (white with color filters for color options), standard color LEDs, etc. The type of LEDs used as light sources 16 may be suited to the application of the display. The quality and degree of light emitted by a display as described herein can depend upon the type of light sources used.

In some embodiments light sources 16 comprise laser diodes. The laser diodes may be of a type that lacks a housing or collimating optics. An aperture of the laser diode may be placed in direct optical contact with an side surface of block 12. The surface may be frosted.

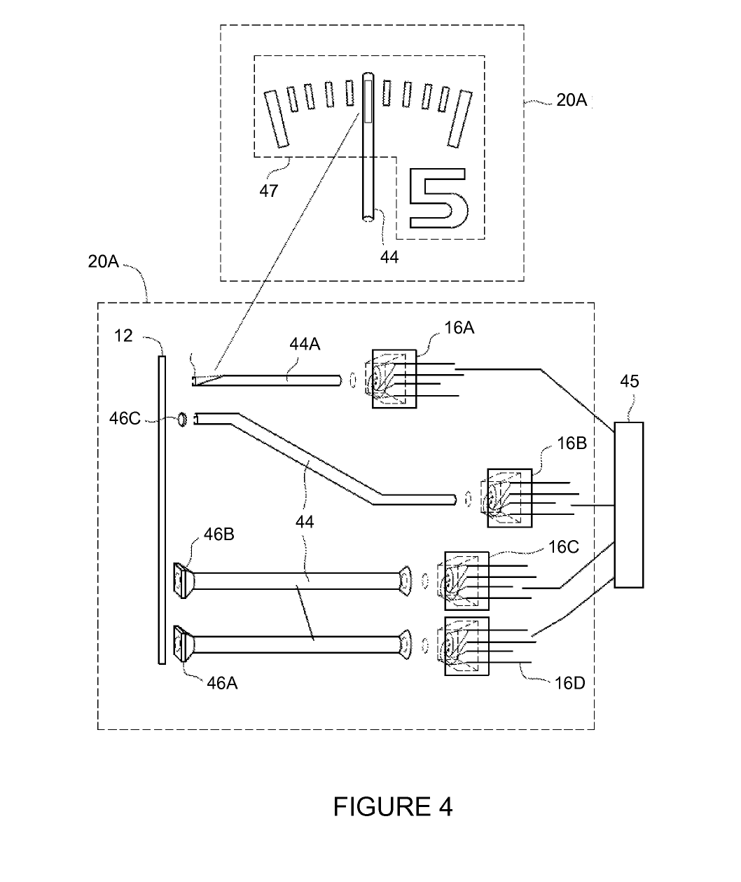

FIG. 4 is a side view of another gauge/indicator 20A that illustrates application of laser engraved panels. Here, fiber optic cables 44 carry light from light sources 16A, 16B, 16C, and 16D to display block 12. Circuitry 45 controls light sources 16A, 16B, 16C, and 16D to illuminate features in block 12 (e.g. patterns as described above) with appropriate colors at appropriate times. In some applications color filters (for example filters 46A, 46B and 46C) are provided to affect the color of light with which features are illuminated. In this case one fiber optic cable 44A also backlights indicia on an engraved layer 47 behind block 12.

In some embodiments, patterns 14 are configured to preferentially scatter light of certain polarizations. In such embodiments, light from light sources 16 corresponding to a particular pattern 14 may be polarized so as to be preferentially scattered by the corresponding pattern 14. Other nearby patterns 14 may be configured to scatter light of other polarizations preferentially. This reduces the degree to which a pattern 14 can unintentionally be made visible by light intended to illuminate an adjacent pattern 14.

Patterns 14 may be made to scatter polarized light preferentially by engraving those patterns 14 using polarized light. For example, some patterns 14 may be engraved using horizontally polarized light and some patterns 14 may be engraved using vertically polarized light. An etch made using circularly polarized light may block both horizontally-polarized and vertically-polarized light. An etch made using circularly polarized light may be applied to advantage in making barriers 18.

In a non-limiting example embodiment, an etch is polarized by slowly heating and cooling the section of block 12 to be etched using a polarized sub surface laser beam. The laser beam may be generated, for example using a frequency doubled 532 nm laser diode operating at a pulse rate of 2 kHz. The laser beam may, for example, have a power of 100 W or less. Temperature of the block prior to etching may be, for example, in the range of 15-30° C.

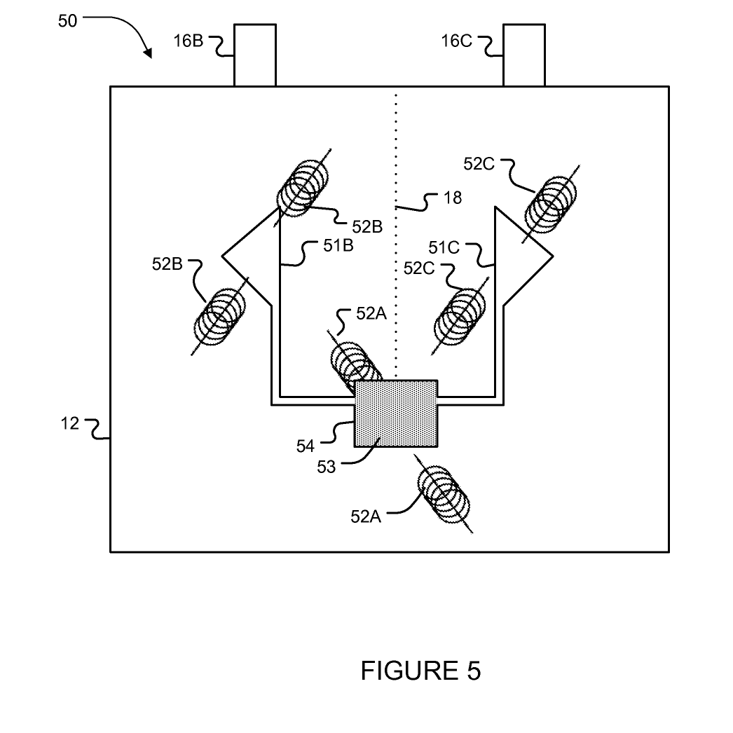

FIG. 5 shows a display 50 according to another example embodiment in which patterns 14 comprise cavities 51 into which a light-scattering fluid may be introduced. In the illustrated embodiment the light-scattering fluid comprises a ferrofluid 53 and display 50 comprises electromagnetic coils 52A, 52B, 52C etc. (collectively or generally coils 52).

Ferrofluids are fluids having ferromagnetic properties. such fluids may comprise colloidal dispersions of small magnetic particles. An example of a ferrofluid that may be used as ferrofluid 53 is an optical-grade ferrofluid comprising magnetic particles carried in ethylene glycol. Such a ferrofluid may be made, for example, by preparing FeCl₃ and FeCl₂ in aqueous hydrochloric acid with a sodium hydroxide and trisodium citrate dehydrate solution added at 6% of the molar ratio of the Ferrous solution for optimal results. Water is then added to produce maghemite (γ-Fe₂O₃) which is stabilized by coating with 2-[2-(2-methoxyethoxy)ethoxy]acetic acid (MOEEAA). A ferrofluid can then be obtained by dispersion of the stabilized particles in ethylene glycol at a weight percentage of particles in the range of 10% -25% for example. Silver nanoparticles with a copper base may be sprayed on the resulting ferrofluid in order to improve its optical properties. The silver particles may, for example have dimensions on the order of 40-60 nm.

Coils 52 generate magnetic fields when energized. The magnetic fields can draw ferrofluid 53 from a reservoir 54 into a selected cavity 51 or vice versa by way of channels 55. Some embodiments have a common reservoir 54 while other embodiments have a reservoir 54 dedicated to each cavity 51. Light sources 16 the same as or similar to those described above may illuminate the ferrofluid-filled chambers 51.

For example, in the illustrated embodiment, ferrofluid 53 may be drawn from all reservoirs 51 into reservoir 54 by switching on coil 52A and switching off all other coils 52. Display 50 may be placed in an ‘inactive’ state by energizing coil 52A switching off other coils 52 and turning off light sources 16.

Ferrofluid 53 may be drawn into cavity 51B by switching on coil 52B, and so on. A ferrofluid-filled cavity 51 may be illuminated in the same manner as patterns 14. FIG. 5 shows an example case in which ferrofluid 53 has been drawn into a triangular cavity 51B by energizing a corresponding coil 52B. Cavity 51B is illuminated by a corresponding light source 16B. This results in a visible left triangle which may serve, for example, as a turn signal indicator. A barrier 18 prevents light from light source 16B from illuminating other portions of display 50.

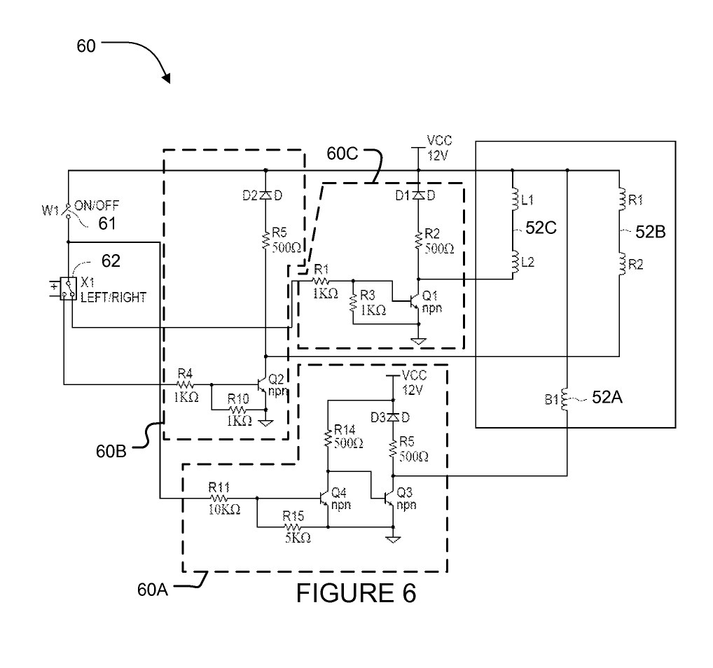

FIG. 6 shows a circuit 60 that may be used to control coils 52 in a display like display 50. Circuit 60 comprises circuits 60A, 60B and 60C that respectively control coils 52A, 52B and 52C. Circuit 60 comprises a switch 61. When switch 61 is OFF, transistor Q3 conducts to energize coil 52A. Coils 52B and 52C are both off. When switch 61 is ON then one of coils 52B and 52C is energized and the other is off. Which coil is energized and which coil is off is determined by the position of switch 62.

When switch 62 is to the right, as illustrated, then circuit 60C energizes coil 52C while circuit 62B keeps coil 62B turned off. When switch 62 is to the left then circuit 60C turns coil 52C off while circuit 62B energizes coil 62B.

A display may combine one or more ferrofluid elements with one or more etched patterns 14. In some embodiments, ferrofluid elements may be configured to selectively block or reveal all or portions of certain etched patterns 14.

Displays as described herein have a wide variety of applications and configurations. The appearance of patterns 14 may be customized for specific applications. For example:
A display may include patterns 14 formed in different layers that are superposed on one another from a viewing location. The patterns may, for example, have the appearance of digits. A desired digit can be made to appear by illuminating the corresponding pattern 14.
A display may include patterns in the form of icons representing certain machine components or functions. For example, a display may include icons representing engine temperature, oil pressure, fuel quantity or the like. The color of the icon may be changed (by controlling appropriate light sources 16 to illuminate the icon) to indicate whether the corresponding machine component or function requires attention. Illumination of the icon may be turned off to make the icon invisible.
A plurality of patterns 14 at different depths with block 12 may form a 3D pattern that may be illuminated together as described herein to provide a signal to a viewer of the display.
Three Dimensional effects or “floating” interfaces may be achieved by layering patterns 14 in two or more layers and using separate sources to edge-light each layer, one darker than the other to simulate shading.
A display may provide low-cost displays for automobiles or the like.
A display may provide a see-through overlay for use as an informational or help template for controls.
Displays may be used for standardized or customized lighting, control and display applications.
A display may be used for decoration and/or lighting (i.e. as a lumiere).

While a number of exemplary aspects and embodiments have been discussed above, those of skill in the art will recognize certain modifications, permutations, additions and sub-combinations thereof. By way of non-limiting example:
In some embodiments at least one side surface of a block sheet or panel is mirrored so as to reflect light propagating in the block sheet or panel back into the block sheet or panel at the mirrored side surface.
A block may have any number of side surfaces. It is not mandatory that the block be rectangular or have any other particular shape.
It is not mandatory that the block have the same thickness (dimension between front and back surfaces) throughout.
A display as described herein may be configured to be used in a modular system. For example, a display may include a modular platform. The modular platform may be coupled to at least one other modular platform by a coupling mechanism, thereby including the display in a modular construction. In some embodiments the modular platform may also support light sources of the display.
One or more features of any one embodiment described and/or illustrated herein may be combined with one or more features of other embodiments described and/or illustrated herein to yield further example embodiments.
   It is therefore intended that the following appended claims and claims hereafter introduced are interpreted to include all such modifications, permutations, additions and sub-combinations as are within their true spirit and scope.

What is claimed is:

1. A display comprising:
an optically transparent block, the block having a front face and one or more sides, the block having defined in it at least one barrier dividing the block into a plurality of segments;
at least one light source associated with each of the segments the light source optically connected to emit light into one of the sides;
at least one patterned area in each of the segments, the patterned area configured to scatter light so as to be visible through the front face when illuminated by the associated light source;
wherein the barrier is configured to block light from the light source associated with one of the segments from illuminating the patterned area in a different one of the segments.

2. A display according to claim 1 wherein the barrier comprises a barrier formed in the block by sub-surface etching.

3. A display according to claim 2 wherein the patterned areas are formed in the block by sub-surface etching.

4. A display according to claim 3 wherein the barrier extends substantially perpendicularly to the front face of the block.

5. A display according to claim 4 wherein the barrier extends from the front face of the block to a rear face of the block.

6. A display according to claim 3 wherein the block comprises a solid block of glass or plastic.

7. A display according to claim 3 wherein one of the patterned areas is configured to preferentially scatter light of a first polarization and the associated light source is configured to emit light of the first polarization into the block.

8. A display according to claim 3 wherein:
in one of the segments, a plurality of the patterned areas are formed in the block at different depths from the front face;
different ones of the plurality of patterned areas in the one segment are configured to preferentially scatter light of different corresponding polarizations;
the at least one light source associated with the one segment comprises a plurality of light sources, each of the plurality of light sources configured to emit into the block polarized light having the polarization corresponding to one of the patterned areas.

9. A display according to claim 1 wherein:
in one of the segments, a plurality of the patterned areas are formed in the block at different depths from the front face;
the at least one light source associated with the one segment comprises a plurality of light sources, each of the plurality of light sources configured to emit into the block in a layer that includes one of the patterned areas and excludes at least one other one of the patterned areas.

10. A display according to claim 1 wherein:
for at least one of the segments the at least one light source comprises one or more light sources configured to selectively emit light one of a plurality of colors into the block whereby the patterned area in the at least one segment may selectively be made visible in any selected one of the plurality of colors.

11. A display according to claim 1 comprising an indicator behind the block and visible through the block from the front face.

12. A display according to claim 11 wherein the indicator comprises an illuminated dial and/or illuminated indicia.

13. A display according to claim 1 wherein the block comprises a plurality of layers supported in parallel relationship to one another.

14. A display according to claim 13 wherein the patterned areas comprise areas patterned on faces of the layers.

15. A display according to claim 13 comprising one or more optical films between the layers wherein the optical films comprise a one-way mirror film oriented to reflect light incident from a direction of the front face.

16. A display according to claim 15 wherein the optical films comprise a diffuser film located on a side of the one-way mirror film away from the front face of the block.

17. A display according to claim 1 wherein the block comprises:
a reservoir and at least a first cavity in fluid communication with the reservoir;
a ferrofluid in the reservoir;
one or more electromagnets configured to vary magnetic field strength in one or both of the first cavity and the reservoir;
a controller configured to operate the one or more electromagnets to selectively move the ferrofluid into or out of the first cavity.

18. An illuminated display comprising:
at least one panel of light transmitting material having a front image display surface and a rear surface opposite thereto;
at least one side surface between the front image display surface and the rear surface;
at least one segmenting subsurface optical barrier extending between the front image display surface and the rear surface, the segmenting subsurface having optical characteristics different from optical characteristics of surrounding material of the panel;
at least one pattern defined by subsurface etching, the pattern located between the front image display surface and the rear surface, the pattern having optical characteristics different from the optical characteristics of the surrounding material of the panel; and
at least one light source placed such that: light from the light source is diffused through a segment of the panel bounded by the segmenting subsurface, the front image display surface and the rear surface, and, upon operation of the light source, the subsurface etch is perceptibly illuminated.

19. An illuminated display according to claim 18 wherein at least one side surface is mirrored.

20. An illuminated display according to claim 18, comprising a visual indicator located behind the rear surface and visible through the panel from the front surface.

21. An illuminated display according to claim 20 wherein the visual indicator comprises an analog gauge.

22. An illuminated display according to claim 18 comprising at least one controller that is configured to control the light source over time so as to produce from the illuminated display at least one dynamic lighting effect.
